(19) United States
(12) Patent Application Publication
(10) Pub. No.: US 2015/0181456 A1
(43) Pub. Date: Jun. 25, 2015

(54) FRAME TRANSMISSION METHOD AND APPARATUS FOR CONTROLLING ONE-WAY DELAY

(71) Applicant: Electronics and Telecommunications Research Institute, Daejeon (KR)

(72) Inventors: Igor KIM, Daejeon (KR); Gwang Zeen KO, Daejeon (KR); Jin Hyung OH, Daejeon (KR); Hyun Duk KANG, Gwangju (KR); Myung Sun SONG, Daejeon (KR)

(21) Appl. No.: 14/490,780

(22) Filed: Sep. 19, 2014

(30) Foreign Application Priority Data
Dec. 19, 2013 (KR) 10-2013-0159460

(51) Int. Cl. H04W 28/02; H04L 12/26; H04L 12/875; H04W 24/08

(52) U.S. Cl. CPC H04W 28/0236; H04W 24/08; H04L 43/0858; H04L 47/56

(57) ABSTRACT

Provided is a frame transmission method and apparatus for controlling a one-way delay, the apparatus determining channel access delay between a reaching time at which at pre previous transmission frame reaches a head of a transmission queue and a transmission time at which the previous transmission frame it actually transmitted, and transmitting a current frame in a transmission mode determined by estimating a probability related to the transmission mode based on the channel access delay.

### CROSS-REFERENCE TO RELATED APPLICATION

This application claims the priority benefit of Korean Patent Application No. 10-2013-0159460, filed on Dec. 19, 2013, in the Korean Intellectual Property Office, the disclosure of which is incorporated herein by reference.

### BACKGROUND

1. Field of the Invention

The present invention relates to a method and apparatus for transmitting a current frame based on a channel access delay between a reaching time at which a previous transmission frame reaches a head of a transmission queue and a transmission time at which the previous transmission frame is actually transmitted.

2. Description of the Related Art

Recently, propagation of a wireless network is progressing rapidly due to low costs, ease of access, and a high connection speed. Rapid growth of the wireless network may be attributed to an increasing number of mobile devices such as smartphones and tablet personal computers (PCs) including a wireless local area network (WLAN) interface. In order to satisfy user requirements in view of a quality of service (QoS) and a quality of experience (QoE), a network may need to adaptively react to a predetermined condition in real-time. In such a situation, understanding which metric has to be controlled is crucial. A one-way delay is a main factor in providing a guaranteed QoS in a real-time application. It is also well known that each application requires different levels of performance in terms of an end-to-end delay.

Not all current wireless networks may provide a method of limiting the one-way delay under a pre-defined limitation. For example, an endpoint such as a base station (BS) or an access point (AP) may have a difficulty when the same channel access rule is applied for each terminal. A downlink delay may increase in proportion to an increasing number of activated user terminals in a single cell.

In general, since terminals and endpoints included in a wireless networks have the same configuration parameter for a channel access, network resources may be equally distributed. When N activated wireless terminals are included in a single cell, a ratio of downstream throughput to upstream throughput may be 1/N. Here, an issue caused due to a downlink delay may be more significantly recognized because an amount of downstream traffic is generally larger than an amount of upstream traffic.

### SUMMARY

An aspect of the present invention provides a frame transmission method and apparatus for effectively controlling a one-way delay in a wireless network by monitoring a channel access delay.

Another aspect of the present invention also provides a frame transmission method and apparatus which may be applicable to all types of applications and a network usage scenario, and implementable with an increased accuracy by updating a channel access delay in real-time.

Still another aspect of the present invention also provides a frame transmission method and apparatus for decreasing a probability of an occurrence of a queue growth and a transmission queue overflow.

Yet another aspect of the present invention also provides a frame transmission method and apparatus applicable for an application susceptible to a delay in a video and sound transmission.

According to an aspect of the present invention, there is provided a frame transmission apparatus including a determiner to determine a channel access delay between a reaching time at which a previous transmission frame reaches a head of a transmission queue and a transmission time at which the previous transmission frame is actually transmitted, an estimator to estimate a probability related to a transmission mode based on the channel access delay, and a transmitter to transmit a current frame in the transmission mode determined based on the probability.

The frame transmission apparatus may further include an updating unit to update the determined channel access delay, based on a channel access delay between a transmission time and a reaching time of the current frame after transmission of the current frame.

The probability may be a function of a channel access delay updated based on the channel access delay between the transmission time and the reaching time of the previous transmission frame.

The transmitter may transmit the current frame in one of a normal transmission mode and a high-speed transmission mode determined by comparing a random number between “0” and “1” generated using a random number generator and the probability.

The high-speed transmission mode may be a transmission mode for acquiring a channel access of the current frame with a priority or a probability higher than that of another network entity.

The high-speed transmission mode may be a transmission mode for acquiring a channel access of the current frame by adjusting at least one of an inter-frame spacing and a contention window corresponding to a channel access parameter of the current frame.

The probability may be “0” with respect to a channel access delay related only to the normal transmission mode, changed with respect to a channel access delay related to both the normal transmission mode and the high-speed transmission mode, and “1” with respect to a channel access delay related only to the high-speed transmission mode.

According to another aspect of the present invention, there is also provided a frame transmission method including determining a channel access delay between a reaching time at which a previous transmission frame reaches a head of a transmission queue and a transmission time at which the previous transmission frame is actually transmitted, estimating a probability related to a transmission mode based on the channel access delay, and transmitting a current frame in a transmission mode determined based on the estimated probability.

The frame transmission method may further include updating the determined channel access delay, based on a channel access delay between a transmission time and a reaching time of the current frame after transmission of the current frame.

The probability may be a function of a channel access delay updated based on the channel access delay between the transmission time and the reaching time of the previous transmission frame.

The transmitter may transmit the current frame in one of a normal transmission mode and a high-speed transmission mode determined by comparing a random number between “0” and “1” generated using a random number generator and the probability.

The high-speed transmission mode may be a transmission mode for acquiring a channel access of the current frame with a priority or a probability higher than that of another network entity.

The high-speed transmission mode may be a transmission mode for acquiring a channel access of the current frame by adjusting at least one of an inter-frame spacing and a contention window corresponding to a channel access parameter of the current frame.

The probability may be “0” with respect to a channel access delay related only to the normal transmission mode, changed with respect to a channel access delay related to both the normal transmission mode and the high-speed transmission mode, and “1” with respect to a channel access delay related only to the high-speed transmission mode.

According to still another aspect of the present invention, there is also provided a frame transmission method including measuring a reaching time at which a current frame reaches a head of a transmission queue, estimating a probability related to a transmission mode based on a channel access delay between a transmission time and a reaching time of a previous transmission frame, transmitting the current frame in a transmission mode determined based on the estimated probability, measuring a transmission time at which the current frame is actually transmitted, and updating the channel access delay based on the reaching time and the transmission time.

The transmitting may include transmitting the current frame in one of a normal transmission mode and a high-speed transmission mode determined by comparing a random number between “0” and “1” generated using a random number generator and the probability.

The probability may be a function of a channel access delay updated based on the channel access delay between the transmission time and the reaching time of the previous transmission frame.

The high-speed transmission mode may be a transmission mode for acquiring a channel access of the current frame with a priority or a probability higher than that of another network entity.

The high-speed transmission mode may be a transmission mode for acquiring a channel access of the current frame by adjusting at least one of an inter-frame spacing and a contention window corresponding to a channel access parameter of the current frame.

The probability may be “0” with respect to a channel access delay related only to the normal transmission mode, changed with respect to a channel access delay related to both the normal transmission mode and the high-speed transmission mode, and “1” with respect to a channel access delay related only to the high-speed transmission mode.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 illustrates a queue growth and overflow at an endpoint according to an example embodiment;

FIG. 2 illustrates factors of a one-way delay in a transmission queue according to an example embodiment;

FIG. 3 illustrates an example of a frame transmission method according to an example embodiment;

FIG. 4 illustrates another example of a frame transmission method according to an example embodiment;

FIG. 5 illustrates a configuration of a frame transmission apparatus according to an example embodiment; and

FIGS. 6 and 7 illustrate a probability based on a channel access delay according to an example embodiment.

### DETAILED DESCRIPTION

Hereinafter, embodiments will be described in more detail with reference to the accompanying drawings.

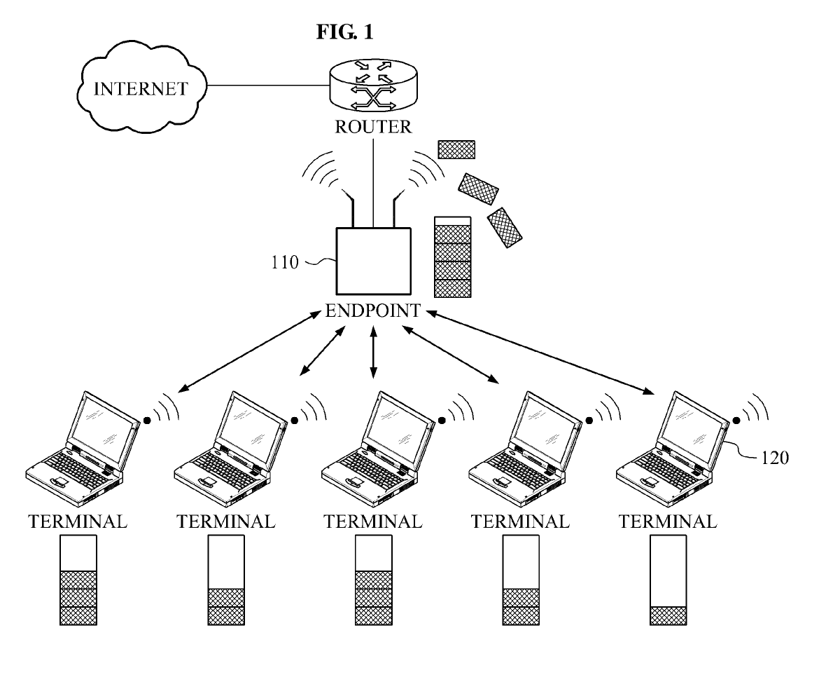

FIG. 1 illustrates a queue growth and overflow at an endpoint according to an example embodiment.

A network topology including a single endpoint 110 and N terminals may be indicated with reference to FIG. 1. The N terminals, for example, a terminal 120 may cause an occurrence of two-way traffic by communicating with another network entity existing on the Internet through the endpoint 110.

In general, a channel access parameter may be identical with respect to all network entities in a wireless network. Thus, the endpoint 110 and the N terminals included in a network entity may have an identical channel access probability. Accordingly, an amount of traffic load of the endpoint 110 may be N times greater than an amount of traffic load of the N terminals.

In this example, a queue size of the endpoint 110 may continuously increase until a limitation is reached. Concisely, a queue growth may be processed at the endpoint 110. When the queue size of the endpoint 110 reaches the limitation, the one-way delay may increase. Also, a packet drop may occur at the endpoint 110 due to a transmission buffer overflow.

The endpoint 110 may be a device for communicating with a terminal, and include an access point (AP), a base station (BS), a frame transmission apparatus, and the like. Hereinafter, descriptions may be provided based on a frame transmission apparatus. Also, the N terminals may be devices for communicating with the endpoint 110, and include a mobile device, a laptop computer, and the like.

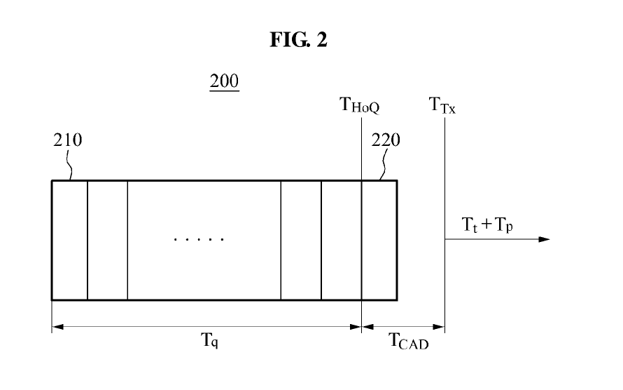

FIG. 2 illustrates factors of a one-way delay in a transmission queue 200 according to an example embodiment.

Referring to FIG. 2, the transmission queue 200 may include a tail 210 and a head 220. The tail 210 may be a portion at which a frame to be transmitted firstly enters the transmission queue 200. The head 220 may be a portion at which the frame entering the transmission queue 200 is transmitted to a terminal. Thus, the frame may move from the tail 210 to the head 220 in the transmission queue 200. The transmission queue 200 may include frames in a standby state to be served.

The one-way delay may include factors, for example, a queuing delay T_{q}, a channel access delay T_{CAD}, a transmission delay Tt, and a propagation delay Tp.

The queuing delay T_{q} may be defined as a duration of the frame entering the tail 210 of the transmission queue 200 and reaching the head 220 of the transmission queue 200. When a network is busy, the queuing delay T_{q} may affect the one-way delay.

The channel access delay T_{CAD}, may be determined based on a reaching time T_{HoQ} at which the frame reaches the head 220 of the transmission queue 200 and a transmission time T_{Tx} at which the frame is actually transmitted. Thus, the channel access delay T_{CAD} may indicate a difference between the reaching time T_{HoQ} and the transmission time T_{Tx}.

The channel access delay T_{CAD} may be used as an indicator related to a current network load/application. The longer a standby of the frame for a channel access in the transmission queue 200, the greater a competition level and an amount of network load. Also, the channel access delay T_{CAD}, may consider retransmission due to a frame error.

The transmission delay Tₜ may indicate a time during which all bits included in the frame are pushed to a channel to be transmitted. Thus, the transmission delay Tₜ may be determined based on a size of the frame and a modulation and coding scheme (MCS) for a data frame/control frame.

The propagation delay Tₚ may indicate a duration during which a signal transmitted from a transmitter reaches a receiver. Thus, the propagation delay Tₚ may depend on a distance between the transmitter and the receiver, and a signal propagation delay.

A queue service time may be regarded as a sum of the channel access delay T_{CAD}, the transmission delay Tₜ, and the propagation delay Tₚ. The queue service time may directly affect the queuing delay T_{q}. Here, the channel access delay T_{CAD} may account for a relatively considerable portion of the queue service time. Thus, the one-way delay may be efficiently controlled through the channel access delay T_{CAD}.

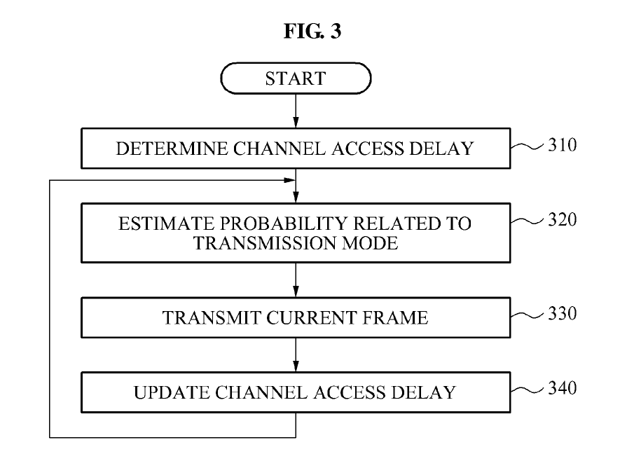

FIG. 3 illustrates an example of a frame transmission method according to an example embodiment.

The frame transmission method according to an example embodiment may be performed by a processor included in a frame transmission apparatus.

Here, a frame may be classified into a previous transmission frame, a current frame, and a subsequent frame. The previous transmission frame may indicate a frame transmitted before transmission of the current frame. The current frame may indicate a frame present in a transmission queue and to be transmitted. The subsequent frame may indicate a frame to be transmitted after transmission of the current frame.

In operation 310, the frame transmission apparatus may determine a channel access delay between a reaching time at which the previous transmission frame reaches a head of the transmission queue and a transmission time at which the previous transmission frame is actually transmitted.

Here, the channel access delay may indicate a difference between the reaching time and the transmission time. For example, the channel access delay may be an average value of channel access delays of previously transmitted frames.

In operation 320, before transmission of the current frame, the frame transmission apparatus may estimate a probability P_{Tx} related to a transmission mode based on the channel access delay. Here, the transmission mode may include a normal transmission mode and a high-speed transmission mode for acquiring a channel access with a priority or a probability higher than that of the normal transmission mode.

The probability P_{Tx} may indicate a probability of the current frame being transmitted in the high-speed transmission mode. For example, the current frame may be transmitted in the high-speed transmission mode, and transmitted in the normal transmission mode based on 1−probability P_{Tx}. As an example, the probability P_{Tx} may be a function of a channel access delay updated based on the channel access delay between the reaching time and the transmission time of the previous transmission frame.

The probability P_{Tx} may be estimated such that the high-speed transmission mode is to be uniformly distributed among normal transmission modes. The probability P_{Tx} may prevent the frame transmission apparatus from aggressively and adversely affecting a transmission of another network entity, and allow a network to be smoothly changed from a low-load state to a high-load state.

In an example, the probability P_{Tx} may be “0” with respect to a channel access delay related only to the normal transmission mode, changed with respect to a channel access delay related to both the normal transmission mode and the high-speed transmission mode, and “1” with respect to a channel access delay related only to the high-speed transmission mode.

In operation 320, the frame transmission apparatus may estimate the probability P_{Tx} related to a transmission mode based on the updated channel access delay. Thus, the frame transmission apparatus may transmit the subsequent frame based on an updated average channel access delay.

In operation 330, the frame transmission apparatus may transmit the current frame in the transmission mode determined based on the probability P_{Tx}. For example, the frame transmission apparatus may transmit the current frame in one of the normal transmission mode and the high-speed transmission mode determined by comparing the probability P_{Tx} and a random number between “0” and “1” generated using a random number generator.

In an example, the frame transmission apparatus may transmit the current frame in the high-speed transmission mode when the random number generated by the random number generator is less than the probability P_{Tx}. When the random number generated by the random number generator is equal to probability P_{Tx}, the frame transmission apparatus may transmit the current frame in a preset transmission mode.

The high-speed transmission mode may be a transmission mode in which the frame transmission apparatus acquires a channel access of the current frame with a priority higher than another network entity. Also, the high-transmission mode may be a transmission mode in which the frame transmission apparatus acquires the channel access of the current frame with a probability higher than a probability of the other network entity.

In the high-speed transmission mode, the channel access may be acquired by adjusting a channel access parameter. For example, in the high-speed transmission mode, the channel access of the current frame may be acquired by adjusting at least one of an inter-frame spacing and a contention window corresponding to the channel access parameter of the current frame. Here, the inter-frame spacing and the contention window may be a wireless local area network (WLAN) channel access parameter.

In contrast, the normal transmission mode may be a transmission mode in which the current frame is transmitted using a common transmission method.

In operation 340, after transmission of the current frame, the frame transmission apparatus may update the channel access delay determined in operation 310 based on the channel access delay between the reaching time and the transmission time of the current frame.

As an example, after transmission or retransmission of the current frame is attempted, the frame transmission apparatus may update the channel access delay based on a result of recent statistical measurement. For example, the frame transmission apparatus may update the channel access delay so as to be an average value of channel access delays of previously transmitted frames.

Since a channel access probability may have undefined characteristics, the frame transmission apparatus may not transmit the current frame based on an instantaneous value of the channel access delay. Thus, the frame transmission apparatus may transmit the current frame using the average value of the channel access delays of the previously transmitted frame. Here, the average value may indicate a history value of the channel access delay.

The frame transmission apparatus may unaggressively transmit a frame by updating the channel access delay determined in operation 310 in rapid response to a dynamic network environment change.

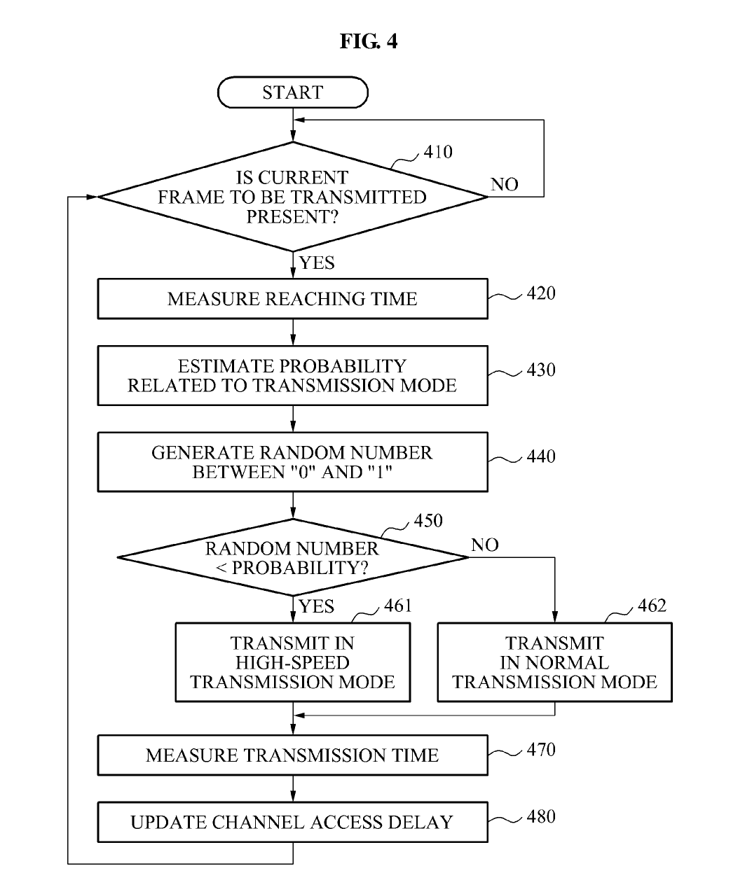

FIG. 4 illustrates another example of a frame transmission method according to an example embodiment.

The frame transmission method according to an example embodiment may be performed by a processor included in a frame transmission apparatus.

In operation 410, the frame transmission apparatus may verify whether a current frame to be transmitted is present by monitoring a transmission queue. When the current frame to be transmitted is absent, the frame transmission apparatus may continuously verify whether a current frame to be transmitted is present.

In operation 410, the frame transmission apparatus may update a channel access delay, and verify whether a current frame to be transmitted is present.

In operation 420, when the current frame to be transmitted is present in the transmission queue, the frame transmission apparatus may measure a reaching time at which the current frame reaches a head of the transmission queue. By recording the measured reaching time, the frame transmission apparatus may use the reaching time when an instantaneous value of the channel access delay of the current frame is estimated.

In operation 430, the frame transmission apparatus may estimate a probability P_{Tx} related to a transmission mode based on a channel access delay between a reaching time and a transmission time of a previous transmission frame. Here, the transmission mode may include a normal transmission mode and a high-speed transmission mode for acquiring a channel access with a priority or a probability higher than that of the normal transmission mode.

The probability P_{Tx} may indicate a probability of the current frame being transmitted in the high-speed transmission mode. Also, the probability P_{Tx} may be a function of a channel access delay updated based on the channel access delay between the reaching time and the transmission time of the previous transmission frame.

In an example, the probability P_{Tx} may be “0” with respect to a channel access delay related only to the normal transmission mode, changed with respect to a channel access delay related to both the normal transmission mode and the high-speed transmission mode, and “1” with respect to a channel access delay related only to the high-speed transmission mode.

In operation 440, the frame transmission apparatus may generate a random number between “0” and “1” using a random number generator.

In operation 450, the frame transmission apparatus may determine one of the normal transmission mode and the high-speed transmission mode by comparing the random number and the probability P_{Tx}.

In operation 461, the frame transmission apparatus may determine that the random number is less than the probability P_{Tx}. In this case, the frame transmission apparatus may transmit the current frame in the high-speed transmission mode.

The high-speed transmission mode may be a transmission mode in which the frame transmission apparatus acquires a channel access of the current frame with a priority or a probability higher than that of another network entity. Also, in the high-speed transmission mode, the channel access may be acquired by adjusting a channel access parameter.

In operation 462, the frame transmission apparatus may determine that the random number is greater than the probability P_{Tx}. In this case, the frame transmission apparatus may transmit the current frame in the normal transmission mode. The normal transmission mode may be a transmission mode in which the current frame is transmitted using a common transmission method.

When the random number is determined to be equal to the probability P_{Tx}, the current frame may be transmitted in a preset mode selected between the normal transmission mode and the high-speed transmission mode.

In operation 470, the frame transmission apparatus may measure a transmission time at which the current frame is actually transmitted. By recording the measured transmission time, the frame transmission apparatus may use the transmission time when the instantaneous value of the channel access delay of the current frame is estimated.

In operation 480, the frame transmission apparatus may update the channel access delay based on the recorded reaching time and transmission time.

As an example, after transmission or retransmission of the current frame is attempted, the frame transmission apparatus may update the channel access delay based on a result of a recent statistical measurement. For example, the frame transmission apparatus may update the channel access delay to be an average value of channel access delays of previously transmitted frames.

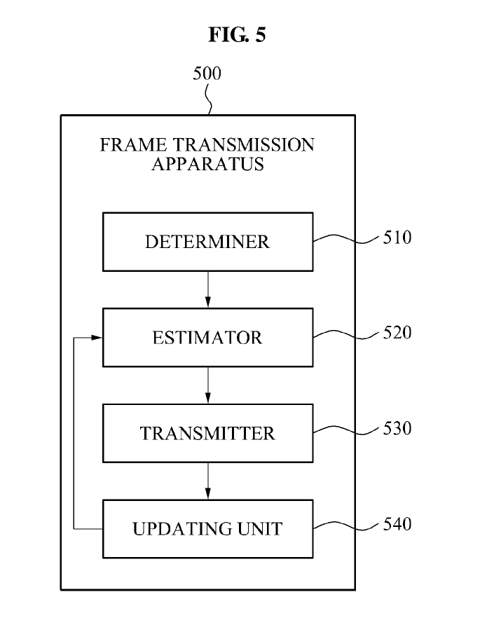

FIG. 5 illustrates a configuration of a frame transmission apparatus 500 according to an example embodiment.

Referring to FIG. 5, the frame transmission apparatus 500 may include a determiner 510, an estimator 520, a transmitter 530, and an updating unit 540.

The determiner 510 may determine a channel access delay between a reaching time at which a previous transmission frame reaches a head of a transmission queue and a transmission time at which the previous transmission frame is actually transmitted.

Here, the channel access delay may indicate a difference between the reaching time and the transmission time. For example, the channel access delay may be an average value of channel access delays of previously transmitted frames.

The estimator 520 may estimate a probability P_{Tx} related to a transmission mode based on the channel access delay determined by the determiner 510. Here, the transmission mode may include a normal transmission mode and a high-speed transmission mode for acquiring a channel access with a priority or a probability higher than that of the normal transmission mode.

The probability P_{Tx} may indicate a probability of a current frame being transmitted in the high-speed transmission mode. For example, the probability P_{Tx} may be a function of a channel access delay updated based on the channel access delay between the reaching time and the transmission time of the previous transmission frame.

In an example, the probability P_{Tx} may be “0” with respect to a channel access delay related only to the normal transmission mode, changed with respect to a channel access delay related to both the normal transmission mode and the high-speed transmission mode, and “1” with respect to a channel access delay related only to the high-speed transmission mode.

The estimator 520 may estimate the probability P_{Tx} related to a transmission mode based on the updated channel access delay. The transmitter 530 may transmit a subsequent frame based on the updated average channel access delay.

The transmitter 530 may determine the transmission mode based on the probability estimated by the estimator 520, and transmit the current frame. For example, the transmitter 530 may transmit the current frame in one of the high-speed transmission mode and the normal transmission mode determined by comparing the probability P_{Tx} and a random number between “0” and “1” generated by a random number generator.

The high-speed transmission mode may be a transmission mode in which the frame transmission apparatus 500 acquires a channel access of the current frame by priority higher than another network entity. Also, the high-transmission mode may be a transmission mode in which the frame transmission apparatus 500 acquires the channel access of the current frame with a probability higher than a probability of the other network entity.

In the high-speed transmission mode, the channel access may be acquired by adjusting a channel access parameter. For example, in the high-speed transmission mode, the channel access of the current frame may be acquired by adjusting at least one of an inter-frame spacing and a contention window corresponding to the channel access parameter of the current frame. Here, the inter-frame spacing and the contention window may be a WLAN channel access parameter.

The updating unit 540 may update a channel access delay related to the current frame based on a channel access delay between a reaching time and a transmission time of the current frame after transmission of the current frame.

As an example, after transmission or retransmission of the current frame is attempted, the updating unit 540 may update the channel access delay based on a result of a recent statistical measurement. For example, the updating unit 540 may update the channel access delay so as to be an average value of channel access delays of previously transmitted frames.

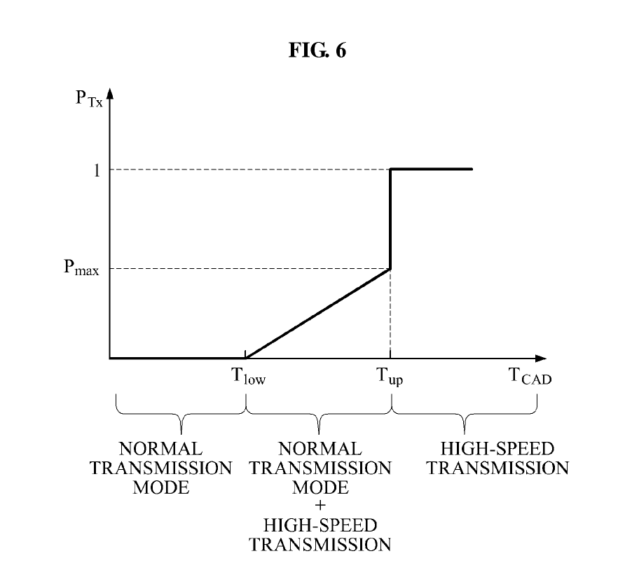

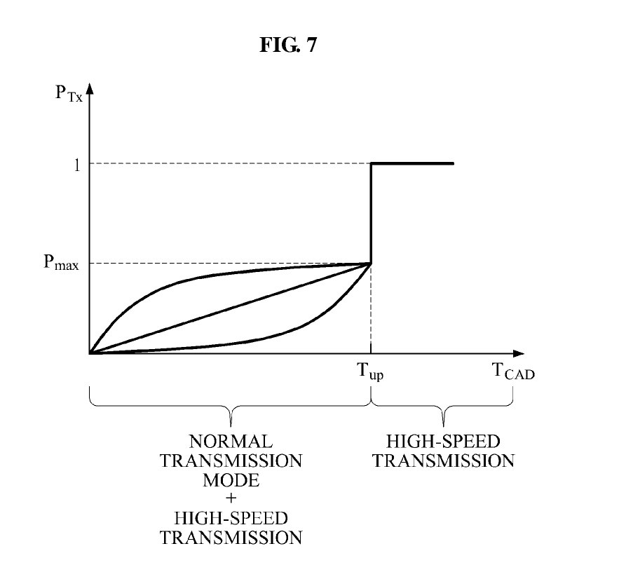

FIGS. 6 and 7 illustrate a probability based on a channel access delay according to an example embodiment.

Referring to FIG. 6, an example of a method of estimating a probability P_{Tx} of a current frame being transmitted in a high-speed transmission mode may be expressed using a function. In FIG. 6, a horizontal axis may indicate a channel access delay T_{CAD}, and a vertical axis may indicate the probability P_{Tx}.

When the channel access delay T_{CAD} is less than a first threshold T_{low}, the probability P_{Tx} may be “0”. Thus, a frame transmission apparatus may transmit the current frame in a normal transmission mode.

As an example, when the channel access delay T_{CAD} is less than the first threshold T_{low}, the channel access delay T_{CAD} may be a channel access delay related only to the normal transmission mode. Thus, the probability P_{Tx} may be “0” with respect to the channel access delay related only to the normal transmission mode.

When the channel access delay T_{CAD} is greater than the first threshold T_{low}, and is less than a second threshold Tᵤₚ greater than the first threshold T_{low}, the probability P_{Tx} may increase proportionally to the channel access delay T_{CAD}. The probability P_{Tx} may increase from “0” up to Pₘₐₓ. Thus, the frame transmission apparatus may transmit the current frame in one of the normal transmission mode and the high-speed transmission mode determined by comparing the probability P_{Tx} and a random number between “0” and “1” generated by a random number generator.

Here, Pₘₐₓ may indicate a maximum probability of the high-speed transmission mode, and may be a preset value. Thus, the frame transmission apparatus may control a maximum probability of a probability of the current frame being transmitted in the high-speed transmission mode using Pₘₐₓ.

In an example, when the channel access delay T_{CAD} is greater than the first threshold T_{low}, and is less than a second threshold Tᵤₚ which is greater than the first threshold T_{low}, the channel access delay T_{CAD} may be a channel access delay related to both the normal transmission mode and the high-speed transmission mode. Thus, the probability P_{Tx} may be changed with respect to the channel access delay related to both the normal transmission mode and the high-speed transmission mode.

When the channel access delay T_{CAD} is greater than the second threshold Tᵤₚ, the probability P_{Tx} may be “1”. Thus, the frame transmission apparatus may transmit the current frame in the high-speed transmission mode. The second threshold Tᵤₚ may be set such that a transmission queue of the frame transmission apparatus is not saturated.

For example, when the channel access delay T_{CAD} is greater than the second threshold Tᵤₚ, the channel access delay T_{CAD} may be a channel access delay related only to the high-speed transmission mode. Thus, the probability P_{Tx} may be “1” with respect to the channel access delay related only to the high-speed transmission mode.

Referring to FIG. 7, another example of a method of estimating a probability P_{Tx} of a current frame being transmitted in a high-speed transmission mode may be expressed using a function. In FIG. 7, a horizontal axis may indicate a channel access delay T_{CAD}, and a vertical axis may indicate the probability P_{Tx}.

When the channel access delay T_{CAD} is less than a threshold Tₜₕ, the probability P_{Tx} may aggressively, constantly, or slowly increase according to an increase in the channel access delay T_{CAD}. The probability P_{Tx} may increase from “0” up to Pₘₐₓ. Thus, the frame transmission apparatus may transmit the current frame in one of the normal transmission mode and the high-speed transmission mode determined by comparing the probability P_{Tx} and a random number between “0” and “1” generated by a random number generator.

Here, Pₘₐₓ may indicate a maximum probability of the high-speed transmission mode, and may be a preset value. Thus, the frame transmission apparatus may control a maximum probability of a probability of the current frame being transmitted in the high-speed transmission mode using Pₘₐₓ.

When the channel access delay T_{CAD} is greater than the threshold Tₜₕ, the probability P_{Tx} may be “1”. Thus, the frame transmission apparatus may transmit the current frame in the high-speed transmission mode. The threshold Tₜₕ may be set such that a transmission queue of the frame transmission apparatus is not to be saturated.

At a peak load state, a one-way delay may rapidly increase by reaching a saturation condition.

FIGS. 6 and 7 may indicate examples of an implementable method of estimating the probability P_{Tx}, while a practical estimation method may be dependent on implementation and application.

According to an aspect of the present invention, it is possible to effectively control a one-way delay in a wireless network by monitoring a channel access delay.

According to another aspect of the present invention, it is possible to provide a frame transmission method and apparatus which may be applicable to all types of applications and a network usage scenario and implementable with an increased accuracy by updating a channel access delay in real-time.

According to still another aspect of the present invention, it is possible to decrease a probability of an occurrence of a queue growth and a transmission queue overflow.

According to yet another aspect of the present invention, it is possible to provide a frame transmission method and apparatus applicable for an application susceptible of a delay in a video and sound transmission.

The units described herein may be implemented using hardware components and software components. For example, the hardware components may include microphones, amplifiers, band-pass filters, audio to digital convertors, and processing devices. A processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple to processing elements and multiple types of processing elements. For example, a processing device may include multiple processors or a processor and a controller. In addition, different processing configurations are possible, such a parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable recording mediums.

The methods according to the above-described embodiments may be recorded, stored, or fixed in one or more non-transitory computer-readable media that includes program instructions to be implemented by a computer to cause a processor to execute or perform the program instructions. The media may also include, alone or in combination with the program instructions, data files, data structures, and the like. The program instructions recorded on the media may be those specially designed and constructed, or they may be of the kind well-known and available to those having skill in the computer software arts. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations and methods described above, or vice versa.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A frame transmission apparatus comprising:
a determiner to determine a channel access delay between a reaching time at which a previous transmission frame reaches a head of a transmission queue and a transmission time at which the previous transmission frame is actually transmitted;
an estimator to estimate a probability related to a transmission mode based on the channel access delay; and
a transmitter to transmit a current frame in the transmission mode determined based on the probability.

2. The apparatus of claim 1, further comprising:
an updating unit to update the determined channel access delay, based on a channel access delay between a transmission time and a reaching time of the current frame after transmission of the current frame.

3. The apparatus of claim 1, wherein the probability is a function of a channel access delay updated based on the channel access delay between the transmission time and the reaching time of the previous transmission frame.

4. The apparatus of claim 1, wherein the transmitter transmits the current frame in one of a normal transmission mode and a high-speed transmission mode determined by comparing a random number between “0” and “1” generated using a random number generator and the probability.

5. The apparatus of claim 4, wherein the high-speed transmission mode is a transmission mode for acquiring a channel access of the current frame with a priority or a probability higher than that of another network entity.

6. The apparatus of claim 4, wherein the high-speed transmission mode is a transmission mode for acquiring a channel access of the current frame by adjusting at least one of an inter-frame spacing and a contention window corresponding to a channel access parameter of the current frame.

7. The apparatus of claim 4, wherein the probability is “0” with respect to a channel access delay related only to the normal transmission mode,
changed with respect to a channel access delay related to both the normal transmission mode and the high-speed transmission mode, and
“1” with respect to a channel access delay related only to the high-speed transmission mode.

8. A frame transmission method comprising:
determining a channel access delay between a reaching time at which a previous transmission frame reaches a head of a transmission queue and a transmission time at which the previous transmission frame is actually transmitted;
estimating a probability related to a transmission mode based on the channel access delay; and
transmitting a current frame in a transmission mode determined based on the estimated probability.

9. The method of claim 8, further comprising:
updating the determined channel access delay, based on a channel access delay between a transmission time and a reaching time of the current frame after transmission of the current frame.

10. The method of claim 8, wherein the probability is a function of a channel access delay updated based on the channel access delay between the transmission time and the reaching time of the previous transmission frame.

11. The method of claim 8, wherein the transmitter transmits the current frame in one of a normal transmission mode and a high-speed transmission mode determined by comparing a random number between “0” and “1” generated using a random number generator and the probability.

12. The method of claim 11, wherein the high-speed transmission mode is a transmission mode for acquiring a channel access of the current frame with a priority or a probability higher than that of another network entity.

13. The method of claim 11, wherein the high-speed transmission mode is a transmission mode for acquiring a channel access of the current frame by adjusting at least one of an inter-frame spacing and a contention window corresponding to a channel access parameter of the current frame.

14. The method of claim 11, wherein the probability is “0” with respect to a channel access delay related only to the normal transmission mode,
changed with respect to a channel access delay related to both the normal transmission mode and the high-speed transmission mode, and
“1” with respect to a channel access delay related only to the high-speed transmission mode.

15. A frame transmission method comprising:
measuring a reaching time at which a current frame reaches a head of a transmission queue;
estimating a probability related to a transmission mode based on a channel access delay between a transmission time and a reaching time of a previous transmission frame;
transmitting the current frame in a transmission mode determined based on the estimated probability;
measuring a transmission time at which the current frame is actually transmitted; and
updating the channel access delay based on the reaching time and the transmission time.

16. The method of claim 15, wherein the probability is a function of a channel access delay updated based on the channel access delay between the transmission time and the reaching time of the previous transmission frame.

17. The method of claim 15, wherein the transmitting comprises transmitting the current frame in one of a normal transmission mode and a high-speed transmission mode determined by comparing a random number between “0” and “1” generated using a random number generator and the probability.

18. The method of claim 17, wherein the high-speed transmission mode is a transmission mode for acquiring a channel access of the current frame with a priority or a probability higher than that of another network entity.

19. The method of claim 17, wherein the high-speed transmission mode is a transmission mode for acquiring a channel access of the current frame by adjusting at least one of an inter-frame spacing and a contention window corresponding to a channel access parameter of the current frame.

20. The method of claim 17, wherein the probability is “0” with respect to a channel access delay related only to the normal transmission mode,
changed with respect to a channel access delay related to both the normal transmission mode and the high-speed transmission mode, and
“1” with respect to a channel access delay related only to the high-speed transmission mode.
